(19) United States
(12) Patent Application Publication
(10) Pub. No.: US 2026/0155949 A1
(43) Pub. Date: Jun. 4, 2026

(54) TIME-AMPLIFIED HYBRID PHASE-LOCKED LOOP

(71) Applicant: Xilinx, Inc., San Jose, CA (US)

(72) Inventors: Andrew Tabalujan, San Jose, CA (US); Parag Upadhyaya, San Jose, CA (US)

(21) Appl. No.: 18/968,957

(22) Filed: Dec. 4, 2024

(51) Int. Cl. H04L 7/033

(52) U.S. Cl. CPC H04L 7/033

(57) ABSTRACT

A phase-locked loop circuit includes a phase-frequency detector circuit, a time amplifier circuit, a control circuit, and a variable oscillator circuit, such as a voltage-controlled oscillator. The phase-frequency detector is configured to generate a phase error output indicating a phase difference between a reference signal and a feedback signal generated using an output signal. The time amplifier is configured to extend the phase difference to generate an extended phase error output. The variable oscillator is configured to use one or more control signals generated by the control circuit using the extended phase error to adjust a frequency of the output signal. The control circuit may generate a proportional control signal using a switched-resistor circuit that includes a pull-up resistor and a pull-down resistor. The control circuit may generate an integral control signal using a capacitive-shared-integration circuit that includes passive integrating components.

### TECHNICAL FIELD

The present invention relates generally to electronic circuits, and, in particular in particular implementations, to phase-locked loop circuits.

### BACKGROUND

A phase-locked loop (PLL) circuit is designed to generate a periodic output signal that has a constant phase relationship with a periodic input signal (i.e., the phase of the output signal is “locked” with the phase of the input signal). PLL circuits find widespread applications in modern electronics, such as in clock generation and recovery for digital systems, frequency synthesis in wireless communication devices, and jitter reduction in data transmission. PLLs can also be used in motor control systems, frequency modulation (FM) demodulators, and for clock distribution in large-scale integrated circuits. In the realm of processors, PLLs can be used to generate multiple clock domains and manage clock skew. One specific clock generation application is the use of a PLL circuit as part of a serializer/deserializer (SerDes) circuit to generate a stable, high-speed clock that is used to serialize parallel data into a high-speed serial data stream in a transmitter.

PLL circuits typically include a phase detector, a control loop, and an oscillator, such as a voltage-controlled oscillator (VCO). There are several categories of PLL circuits, relating to various aspects of implementation and functionality. PLL circuits may be designed to be analog (APLL), include some digital components such as a digital phase detector (DPLL), or be all-digital (ADPLL). One common type of PLL circuit is the charge-pump PLL (CP-PLL), which uses a phase-frequency detector (PFD) and a charge pump to convert phase error to voltage. A PLL circuit may also be categorized by the implementation of the oscillator. For example, a ring oscillator PLL uses a chain of inverters to create a VCO while an LC-tank PLL uses an inductor-capacitor resonant circuit as a VCO.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an example phase-locked loop (PLL) circuit that includes a time amplifier (TA) circuit coupled between a phase-frequency detector (PFD) circuit and a control circuit configured to output one or more control signals to a variable oscillator circuit in accordance with implementations of the invention;

FIG. 2 illustrates an example PLL circuit that includes a TA circuit coupled between a PFD circuit and a control circuit configured to output one or more control signals to a voltage-controlled oscillator (VCO) circuit where the control circuit has a proportional path outputting a proportional control signal to the VCO circuit and an integral path outputting one or more integral control signals to the VCO circuit in accordance with implementations of the invention;

FIG. 3 illustrates an example PLL circuit that includes a TA circuit coupled between a PFD circuit and a control circuit with a proportional path and an integral path where the proportional path has a switched-resistor proportional (SRP) circuit and where the integral path has a capacitive-shared-integration (CSI) circuit in accordance with implementations of the invention;

FIG. 4 illustrates another example PLL circuit that includes a TA circuit coupled between a PFD circuit and a control circuit with a proportional path with an SRP circuit and an integral path with a CSI circuit where the integral path is configured to output a second integral control signal in accordance with implementations of the invention;

FIG. 5 illustrates an example TA circuit that includes a main discharge path and a dependent discharge path for each of an input UP signal and an input DOWN signal, where the TA circuit is configured to disable the dependent discharge path corresponding to the signal that discharges second in accordance with implementations of the invention;

FIG. 6 illustrates an example VCO circuit that includes a series of inverters coupled to a proportional control signal and one or more integral control signals through corresponding capacitive elements in accordance with implementations of the invention;

FIG. 7 illustrates an example digital VCO (DVCO) circuit that includes a series of inverters coupled to a proportional control signal, an integral control signal, and an m-bit digital control through corresponding capacitive elements in accordance with implementations of the invention; and

FIG. 8 illustrates an example PLL circuit that includes multiple TA circuits cascaded between a PFD circuit and a control circuit configured to output one or more control signals to a variable oscillator circuit in accordance with implementations of the invention.

Corresponding numerals and symbols in the different figures generally refer to corresponding parts unless otherwise indicated. The figures are drawn to clearly illustrate the relevant aspects of the implementations and are not necessarily drawn to scale. The edges of features drawn in the figures do not necessarily indicate the termination of the extent of the feature.

### DETAILED DESCRIPTION OF ILLUSTRATIVE IMPLEMENTATIONS

The making and using of various implementations are discussed in detail below. It should be appreciated, however, that the various implementations described herein are applicable in a wide variety of specific contexts. The specific implementations discussed are merely illustrative of specific ways to make and use various implementations, and should not be construed in a limited scope.

Reference to “an implementation,” “one implementation,” “an implementation,” or “one implementation” in the framework of the present description is intended to indicate that a particular configuration, structure, or characteristic described in relation to the implementation/implementation is included in at least one implementation/implementation. Hence, phrases such as “in one implementation” or “in one implementation” that may be present in one or more points of the present description do not necessarily refer to one and the same implementation/implementation. Moreover, particular conformations, structures, or characteristics may be combined in any adequate way in one or more implementations/implementations. The references used herein are provided merely for convenience and do not define the extent of protection or the scope of the implementations/implementations.

The trend of aggressive die shrink continues to drive the need for a small footprint circuit block to improve silicon efficiency. Conventional CP-PLL circuits (i.e., charge-pump analog PLL circuits) occupy a significant amount of chip area due to the inclusion of a large loop filter capacitor (e.g., to implement integral control for a type-II PLL response). PLL circuits that use digital components, such as DPLL circuits and ADPLL circuits, obviate the need for large loop filter area. However, the quantization error added by digital loop components manifest as deterministic jitter (DJ) at the PLL output. The quantization error may be suppressed by lowering the PLL bandwidth, but this may increase the oscillator noise contribution and in turn result in higher oscillator power to counter the noise contribution.

Due to the respective drawbacks of the above approaches, “hybrid” PLL circuits that attempt to combine the advantages of quantization error-free control afforded by analog PLL circuits (e.g., CP-PLL circuits) with the small area and scalability of digital control components have been designed. Yet, conventional implementations of hybrid PLL circuits use voltage mode control paths that suffer from a headroom limitation based on the voltage supply (e.g., VDD/2). For example, the bandwidth of conventional CP-PLL circuits may be dominated by the proportional term of the control voltage, equal to the charge pump current multiplied by a resistance value (Icp*Rz), and may be higher than the bandwidth of conventional hybrid PLL circuits. Therefore, hybrid PLL circuits with improved PLL bandwidth that maintain the advantages of quantization error-free control, small area, and scalability may be desirable.

In various implementations, a PLL circuit generates and output signal that has a constant phase relationship with a reference signal. The PLL circuit includes a PFD circuit (phase-frequency detector), a TA circuit (time amplifier), a control circuit, and a variable oscillator circuit. The TA circuit is configured to extend the phase difference of a phase error output indicating the phase difference between the reference signal and a feedback signal to output an extended phase error output to the control circuit. The feedback signal is generated using the output signal. The inclusion of the TA circuit before the control circuit may advantageously reduce or eliminate the PLL bandwidth limitation (e.g., caused by a voltage gain limitation due to limited headroom of the control circuit) without increasing the oscillator gain, such as in a proportional path of the PLL.

Specifically, the PFD circuit is configured to receive the reference signal and the feedback signal and generate the phase error output to the TA circuit, which is configured to extend the phase difference by a time scaling factor and generate the extended phase error output. The control circuit is configured to output one or more control signals generated using the extended phase error output to the variable oscillator circuit (e.g., a VCO circuit), which is configured to use the one or more control signals to adjust the frequency of the output signal of the PLL circuit.

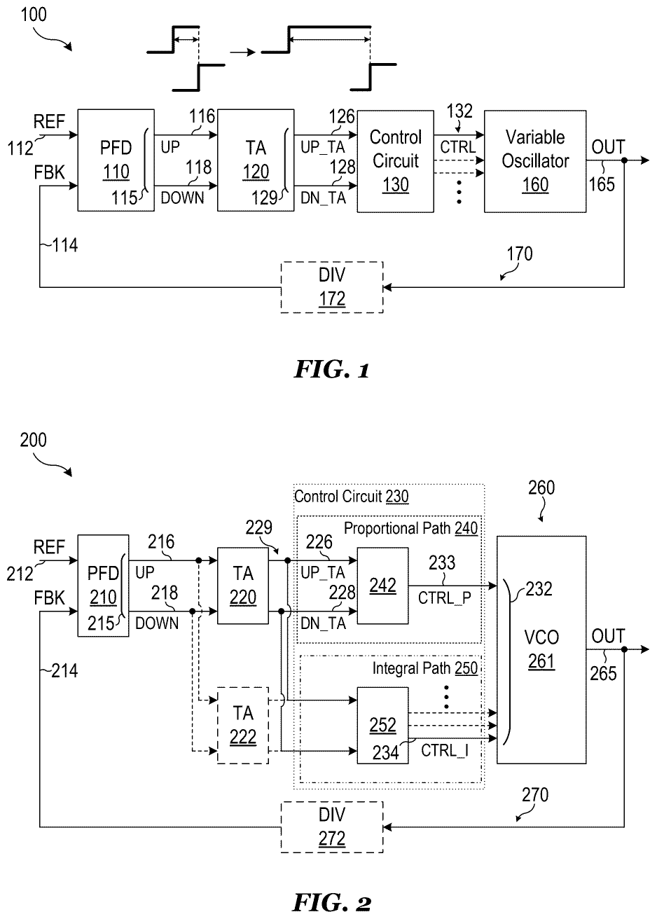

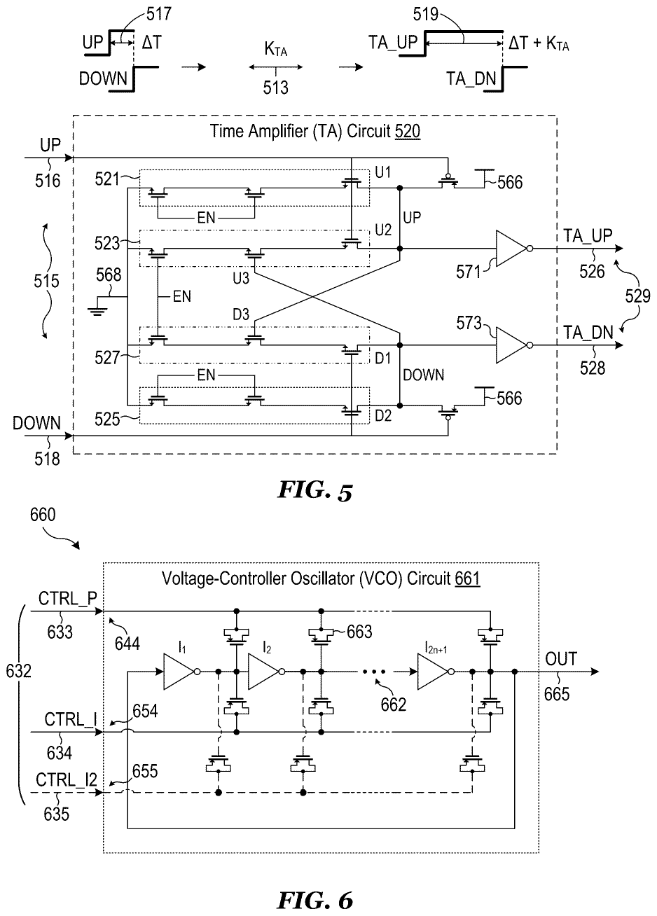

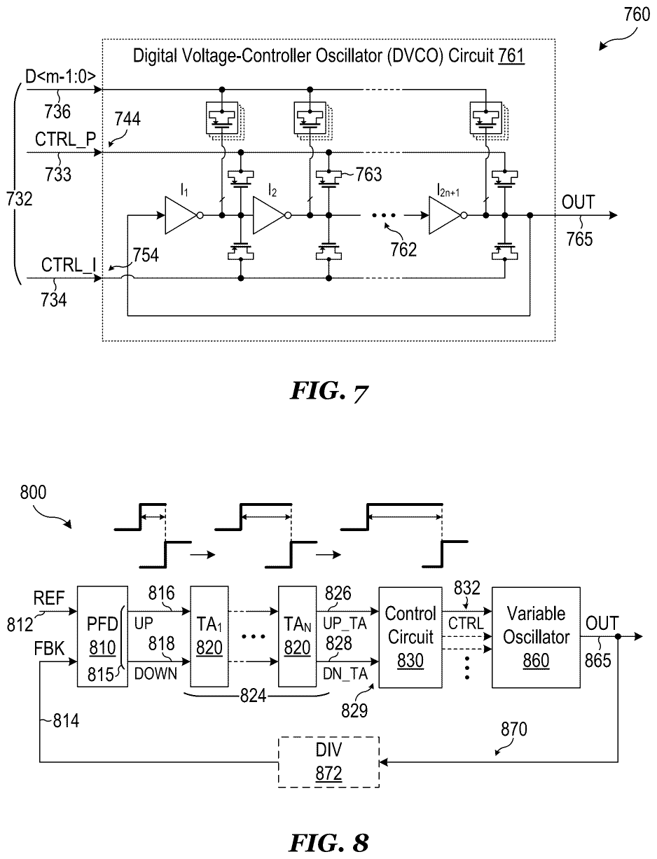

Implementations provided below describe various PLL circuits, and in particular, PLL circuits that include a TA circuit coupled between a PFD circuit and a control circuit configured to control a variable oscillator circuit. The following description describes the implementations. FIG. 1 is used to describe an example PLL circuit. Three more example PLL circuits are described using FIGS. 2-4. An example TA circuit is described using FIG. 5. Two example variable oscillator circuits are described using FIGS. 6 and 7 while FIG. 8 is used to described an example PLL circuit.

FIG. 1 illustrates an example PLL circuit that includes a TA circuit coupled between a PFD circuit and a control circuit configured to output one or more control signals to a variable oscillator circuit in accordance with implementations of the invention.

Referring to FIG. 1, a PLL circuit 100 includes a PFD circuit 110 configured to generate a phase error output 115 indicating the phase difference between a pair of signals. The PFD circuit 110 may include analog and/or digital components and is a digital logic circuit in one implementation. In other implementations, the PFD circuit 110 is an analog circuit, such as a frequency mixer or an analog multiplier. The phase error output 115 may be designed to indicate the phase difference in various ways and may include one or more phase error signals. For example, the PFD circuit 110 may produce a pair of signals with the difference in the leading edges of the signals indicating the phase difference. On alternative configuration of the PFD circuit 110 may produce mutually exclusive output signals with one output indicating when one input signal is leading and the other output indicating with the other input signal is leading.

In this example implementation, the PLL circuit 100 is configured to receive a reference signal 112 (REF) and a feedback signal 114 (FBK) and then output an UP signal 116 and a DOWN signal 118 as the phase error output 115. The phase error output 115 is provided to a TA circuit 120 that is configured to extend the phase difference by a time scaling factor (e.g., amplify the phase difference between the UP signal 116 and the DOWN signal 118 of the PFD circuit 110) and generate an extended phase error output 129 that here includes a TA UP signal 126 (UP_TA) and a TA DOWN signal 128 (DN_TA). For example, the TA circuit 120 may be configured to delay the TA DOWN signal 128 when the rising edge of the TA UP signal 126 is received first and to delay the TA UP signal 126 when the rising edge of the TA DOWN signal 128 is received first.

A control circuit 130 receives the extended phase error output 129 and uses the TA UP signal 126 and the TA DOWN signal 128 to generate one or more control signals 132. The one or more control signals 132 (CTRL) are used to control a variable oscillator circuit 160, such as to adjust the frequency of an output signal 165 (OUT) of the PLL circuit 100. The variable oscillator circuit 160 may be implemented in any suitable fashion. In various implementations, the variable oscillator circuit 160 is a VCO circuit and is a ring VCO circuit in one implementation. In another implementation, the variable oscillator circuit 160 is an LC-tank VCO circuit. The variable oscillator circuit 160 may also include digital control, and is a digital voltage-controlled oscillator (DVCO) circuit in one implementation.

The output signal 165 has a constant phase relationship with the reference signal 112 and a frequency defined by the variable oscillator circuit 160. For example, the frequency of the output signal 165 may be related to one or more voltage inputs of the variable oscillator circuit 160 (as in a VCO). In various implementations, the output signal 165 is a clock signal (e.g., a high frequency clock signal used for serialization of parallel data, for example). The PLL circuit 100 achieves a phase lock between the reference signal 112 and the output signal 165 (i.e., the constant phase relationship) using a feedback signal 114 that it is generated using the output signal 165.

The implementation of the feedback signal 114 may depend on the desired output frequency relative to the reference frequency. In some applications (e.g., for clock recovery) the output signal 165 may be provided directly to the PFD circuit 110 using a feedback loop 170. In other implementations, a frequency divider circuit 172 may optionally be included in the feedback loop 170 (so that the reference signal 112 has a lower frequency than the output signal 165). That is, the feedback signal 114 has a frequency that is related to the frequency of the output signal 165 by a frequency scaling factor (which may be 1 when the frequency divider circuit 172 is omitted). In various implementations, the frequency divider circuit 172 may divide the frequency of the output signal 165 by a multiple of two, such as when the frequency divider circuit 172 is implemented using cascaded flip-flops as a digital frequency divider. In some implementations, the frequency divider circuit 172 is a fractional frequency divider allowing the relationship between the frequency of the reference signal 112 and the frequency of the output signal 165 to be any desired integer N, as in a fractional-N divider.

The PLL circuit 100 may be implemented using any suitable circuit components. In various implementations, the PLL circuit 100 is an integrated circuit. The PLL circuit 100 may be a fully analog circuit (APLL), fully digital circuit (ADPLL), or a mixture analog and digital circuits (DPLL). For example, the control circuit 130 may generate various control signals along certain paths, which may be analog, pseudo-digital, or digital. In various implementations, the control circuit 130 is a hybrid control circuit that generates at least two control signals. In many applications, such as integrated circuit applications, it may be desirable to reduce the size of the PLL circuit 100. The behavior of the PLL circuit 100 may also depend on the details of a given application. For example, the PLL circuit 100 may have a type-I response (e.g., using a single loop filter and tracking frequency only with a steady-state phase error or a type-II response (e.g., using a multi-stage loop filter and tracking both frequency and phase changes with zero steady-state error). Some example implementations of the PLL circuit 100 as a type-II PLL circuit are subsequently discussed in more detail.

As previously mentioned, it may be desirable to increase the bandwidth of the PLL circuit 100, such as to increase the range of available output frequencies (e.g., wide frequency tuning range for data modulation), improve jitter performance, suppress oscillator phase noise, and reduce power consumption. The PLL bandwidth may be described as the frequency range over which the PLL circuit 100 can track changes in the input signal (the reference signal 112). However, the PLL bandwidth may be limited by various factors that may be limited for other reasons specific to a given application. For example, in various implementations, the control circuit 130 includes voltage mode circuitry that has headroom limitations based on the supply voltage. The inclusion of the TA circuit 120 in the PLL circuit 100 may be have the advantage of increasing the PLL bandwidth of the PLL circuit 100 without changing other circuit properties, such as increasing the supply voltage, oscillator gain (e.g., VCO gain), or chip area.

FIG. 2 illustrates an example PLL circuit that includes a TA circuit coupled between a PFD circuit and a control circuit configured to output one or more control signals to a VCO circuit where the control circuit has a proportional path outputting a proportional control signal to the VCO circuit and an integral path outputting one or more integral control signals to the VCO circuit in accordance with implementations of the invention. The PLL circuit of FIG. 2 may be a specific implementation of other PLL circuits described herein such as the PLL circuit of FIG. 1, for example. Similarly labeled elements may be as previously described.

Referring to FIG. 2, a PLL circuit 200 includes a PFD circuit 210 configured to output an UP signal 216 and a DOWN signal 218 as a phase error output 215 indicating the phase difference between a reference signal 212 (REF) and a feedback signal 214 (FBK) that is provided via a feedback loop 270 (with or without a frequency divider circuit 272) using an output signal 265 (OUT). The phase error output 215 is provided to a TA circuit 220 that is configured to amplify the phase difference between the UP signal 216 and the DOWN signal 218 to generate an extended phase error output 229 that includes a TA UP signal 226 (UP_TA) and a TA DOWN signal 228 (DN_TA). It should be noted that here and in the following a convention has been adopted for brevity and clarity wherein elements adhering to the pattern [x20] where ‘x’ is the figure number may be related implementations of a TA circuit in various implementations. For example, the TA circuit 220 may be similar to the TA circuit 120 except as otherwise stated. An analogous convention has also been adopted for other elements as made clear by the use of similar terms in conjunction with the aforementioned numbering system.

A control circuit 230 receives the extended phase error output 229 and uses the TA UP signal 226 and the TA DOWN signal 228 to generate one or more control signals 232. The one or more control signals 232 are used to control a variable oscillator circuit 260, which is here implemented as a VCO circuit 261, to adjust the frequency of an output signal 265 (OUT) of the PLL circuit 200. In this specific implementation, the control circuit 230 generates multiple control signals using a proportional path 240 and an integral path 250. The proportional path 240 includes a proportional control signal generation circuit 242 that is configured to receive the TA UP signal 226 and the TA DOWN signal 228 and to generate a proportional control signal 233 (CTRL_P) of the one or more control signals 232.

The integral path 250 includes an integrator circuit 252 that is also configured to use the TA UP signal 226 and the TA DOWN signal 228, whether by receiving them directly, or by using an additional TA circuit 222 that receives the UP signal 216 and the DOWN signal 218. There may be advantages to either approach. For example, using a single TA circuit may improve the synchronization of the one or more control signals 232. However, using multiple TA circuits may provide improved flexibility in the implementations of the proportional path 240 and the integral path 250. The integral path 250 uses the TA UP signal 226 and the TA DOWN signal 228 to generate at least one integral control signal 234 (CTRL_I).

In various implementations, proportional control signal generation circuit 242 is an analog circuit. However, in contrast to conventional analog PLL circuits (such as CP-PLLs), the area that the proportional control signal generation circuit 242 occupies may be made much smaller (e.g., by not including large capacitors necessary for charge pumps). Similarly, the integrator circuit 252 may be a pseudo-digital circuit, and may include only passive integrating components, such as resistors and capacitors. For example, the integrator circuit 252 may include predominantly or entirely simple components such as capacitors and switches. The proportional path 240 and the integral path 250 may be analogous to the resistance (Rz) and capacitance (1/sCz) of a conventional PLL circuit, such as a conventional CP-PLL, except representing a more sophisticated approach and have various benefits, such as occupying smaller chip area, for example.

The dual-path approach of PLL circuit 200 may have the benefit of eliminating the need for the proportional path 240 to support a wide frequency tuning range. That is, proportional path 240 itself may have a relaxed PLL bandwidth requirement when not considering the TA circuit 220, which may expand the PLL bandwidth. The desired response of the PLL circuit 200 for a given application may influence the VCO gain of the various control loop paths. For example, in some implementations a type-II response may be desirable with small peaking (e.g., <1 dB in the jitter transfer function). For this condition, the VCO gain (i.e., the frequency response of the VCO circuit 261 per input voltage) of the integral path 250 may be made smaller (e.g., around about 150 MHz/V in some implementations) than the VCO gain of the proportional path 240 (e.g., around about 1200 MHz/V).

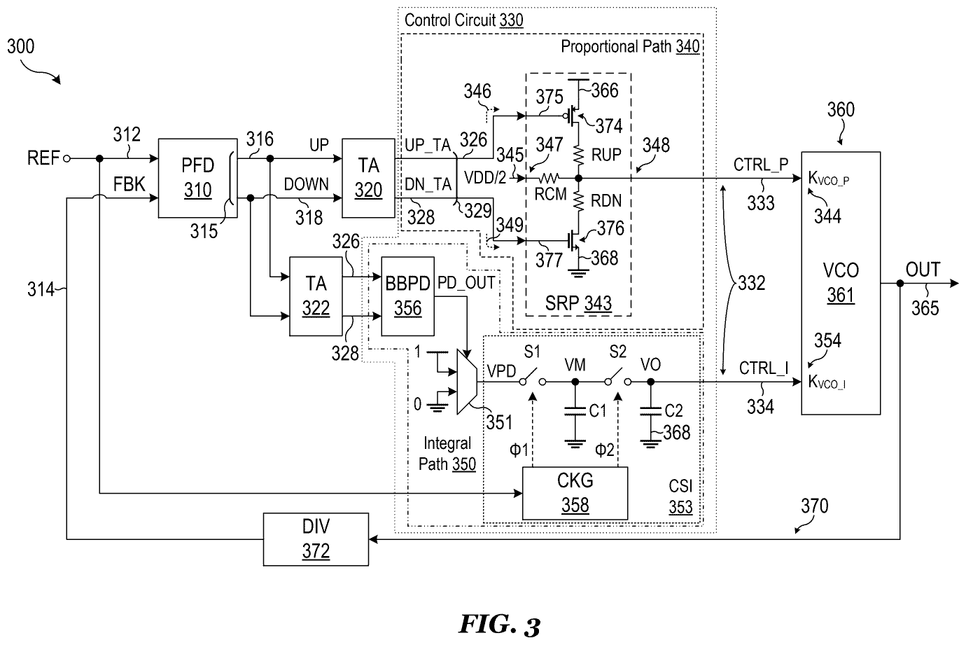

FIG. 3 illustrates an example PLL circuit that includes a TA circuit coupled between a PFD circuit and a control circuit with a proportional path and an integral path where the proportional path has a switched-resistor proportional (SRP) circuit and where the integral path has a capacitive-shared-integration (CSI) circuit in accordance with implementations of the invention. The PLL circuit of FIG. 3 may be a specific implementation of other PLL circuits described herein such as the PLL circuit of FIG. 2, for example. Similarly labeled elements may be as previously described.

Referring to FIG. 3, a PLL circuit 300 includes a PFD circuit 310 configured to output an UP signal 316 and a DOWN signal 318 as a phase error output 315 indicating the phase difference between a reference signal 312 (REF) and a feedback signal 314 (FBK) that is provided via a feedback loop 370 by passing an output signal 365 (OUT) through a frequency divider circuit 372. The phase error output 315 is provided to both a TA circuit 320 and an additional TA circuit 322 that that are each configured to amplify the phase difference between the UP signal 316 and the DOWN signal 318 to generate an extended phase error output 329 that includes a TA UP signal 326 (UP_TA) and a TA DOWN signal 328 (DN_TA).

A control circuit 330 receives the extended phase error output 329 and uses the TA UP signal 326 and the TA DOWN signal 328 to generate one or more control signals 332. The one or more control signals 332 are used to control a variable oscillator circuit 360, which is here implemented as a VCO circuit 361, to adjust the frequency of an output signal 365 (OUT) of the PLL circuit 300. The control circuit 330 generates multiple control signals using a proportional path 340 and an integral path 350.

The proportional path 340 includes a proportional control signal generation circuit implemented as an SRP circuit 343 (a switched-resistor proportional circuit) that is configured to receive the TA UP signal 326 and the TA DOWN signal 328 and to generate a proportional control signal 333 (CTRL_P) of the one or more control signals 332. The integral path 350 includes an integrator circuit implemented as a CSI circuit 353 (a capacitive-shared-integration circuit) that is also configured to use the TA UP signal 326 and the TA DOWN signal 328 generated from the additional TA circuit 322 to generate at least one integral control signal 334 (CTRL_I).

In this specific example circuit, the SRP circuit 343 of the proportional path 340 has an upper path 346 with a pull-up switch 374 (e.g., a p-type transistor, such as a p-type metal-oxide-semiconductor (PMOS) transistor, as shown) controlling voltage to a pull-up resistor RUP from a supply voltage 366 and a lower path 349 with a pull-down switch 376 (e.g., an n-type transistor, such as a n-type MOS (NMOS) transistor, as shown) controlling voltage to a pull-down resistor RDN from a ground voltage 368. The SRP circuit 343 receives an intermediate input voltage 345 (here VDD/2) at a proportional input 347. When both the pull-up switch 374 and the pull-down switch 376 are open, the SRP circuit 343 is configured to output a common mode voltage at a proportional output 348 through a common mode resistor RCM (e.g., about VDD/2).

When both switches are closed, the SRP circuit 343 outputs VDD/2. A pull-up control input 375 (e.g., a gate of a transistor switch) of the pull-up switch 374 is coupled to the TA UP signal 326 while a pull-down control input 377 (e.g., a gate of a transistor switch) of the pull-down switch 376 is coupled to the TA DOWN signal 328. When only one switch is closed, the voltage at the proportional output 348 is pulled up or down depending on which switch is closed. The proportional output 348 is provided to a proportional gain input 344 (K_{VCO_P}) of the VCO circuit 361 as the proportional control signal 333 (CTRL_P).

To illustrate how the proportional path 340 with the SRP circuit 343 functions, a transient example may be considered where both rising edges of the TA UP signal 326 and the TA DOWN signal 328 are aligned. In an implementation where the pull-up resistor RUP and pull-down resistor RDN resistor are matched, the UP and DOWN current (controlled by the upper path 346 and the lower path 349, respectively) will be equal and no change in the direct current (DC) control voltage occurs. If the reference signal 312 (REF) is late by a time dT compared to the feedback signal 314 (FBK), the TA DOWN signal 328 will be active for dT longer than UP signal. This results in a net down current of (VDD/2)/(RCM+RDN) for dT duration and the resulting voltage change dV=[dT*(VDD/2)*RDN/(RCM+RDN)].

The gain of the proportional path 340 may be adjusted by changing the size of the RUP and RDN switched resistors. Yet, as discussed in the foregoing, the operation of the SRP circuit 343 of the proportional path 340 may be a voltage mode path (as opposed to current mode), which may have a headroom limitation based on the supply voltage (VDD) that limits the proportional VCO gain and may in turn limit the PLL bandwidth. Therefore, the gain of the proportional path 340 may only be increased to a certain point, which may be lower than the corresponding proportional term of a conventional CP-PLL design (Icp*Rz). However, leveraging the TA circuit 320 (and the additional TA circuit 322 in this specific example) inserted before the SRP circuit 343, a desirably higher PLL bandwidth may be achieved without designing a large VCO gain in the proportional path (K_{VCO_P}).

Another option for increasing the PLL bandwidth may be to increase the VCO gain, but this may undesirably increase output noise, such as by producing spurs (periodic jitter). Therefore, in some cases, it may be desirable to have lower VCO gain while still achieving a target PLL bandwidth using a voltage mode proportional path design, such as the SRP circuit 343.

As a specific implementation of a PLL circuit with a proportional path and an integral path, the dual-path approach of the PLL circuit 300 may advantageously reduce or eliminate the need for the proportional path to support a wide frequency tuning range. Once the PLL circuit 300, the SRP circuit 343 only handles the proportional portion, keeping the control voltage (CTRL_P) stable around the common mode voltage of half the supply voltage (VDD/2). This may allow for simpler switched-resistor implementation with improved flicker noise performance compared to conventional PLL circuits, such as conventional CP-PLLs.

A specific example of the CSI circuit 353 is also shown, including a passive integration stages separated by switches. The CSI circuit 353 receives a digital phase detector output signal VPD from a selector circuit 351 (e.g., a multiplexer that selects a logical high or a logical low input signal). The logic value that is selected by the selector circuit 351 is controlled by a binary phase detector coupled to the TA UP signal 326 and the TA DOWN signal 328 generated by the additional TA circuit 322, here implemented as a BBPD circuit 356 (a bang-bang phase detector circuit). In other implementations, the BBPD circuit 356 may be a different type of binary PD circuit. The BBPD circuit 356 is configured to generate a binary output signal PD_OUT indicating whether the TA UP signal 326 leads the TA DOWN signal 328 or vice versa.

In this specific implementation, the CSI circuit 353 includes two passive integration stages. A first integrating capacitor C1 is coupled between a middle node VM and the ground voltage 368 and a first switch S1 is coupled between VPD and VM. Similarly, a second integrating capacitor C2 is coupled between an output node VO and the ground voltage 368 and a second switch S2 is coupled between VM and VO. In various implementations, C1 is smaller than C2, the exact proportion being determined by the specific details of a given application.

The switches S1 and S1 are controlled by respective clock signals Φ1 and Φ2, which in this implementation are generated using a CKG circuit 358 (a non-overlapping clock generator circuit). The CKG circuit 358 receives the reference signal 312 at an input and is configured to generate the first clock signal Φ1 and the second clock signal Φ2, which are non-overlapping signals. As the switches S1 and S2 are toggled off and on by the clock signals Φ1 and Φ2, the PD_OUT signal from the BBPD circuit 356 controls whether or not the capacitor C1 accumulates charge (i.e., charges or discharges), which is shared with the capacitor C2. The voltage at the output node VO is provided to an integral gain input 354 (K_{VCO_I}) of the VCO circuit 361 as the integral control signal 334.

The integral path 350 may function by quantizing the time-amplified output of the PFD circuit 310 (the TA UP signal 326 and the TA DOWN signal 328) using the BBPD circuit 356 (e.g., a D flip-flop, for example) which detects the sign of the phase difference (PD_OUT). The additional TA circuit 322 between the PFD circuit 310 and the BBPD circuit 356 may reduce the metastability window of the BBPD circuit 356 thereby improving the jitter reduction of the PLL performance.

The ratio between the capacitance of C1 and C2 may be chosen to be small (e.g., to lower the step size of the integral path 350). The two non-overlapping clock signals Φ1 and Φ2 control the switches S1 and S2 (e.g., functioning as master and slave switches) to ensure they do not close simultaneously, which could cause the charge to directly affect C2, disrupting the integration process. When S1 is closed and S2 is open, the output polarity PD_OUT of the BBPD circuit 356 determines whether C1 is charged to “1” or discharged to “0” through the operation of the selector circuit 351. When S1 is open and S2 is closed, the charge in C1 is shared with C2. The integral control signal 334 (CTRL_I) will increment or decrement by about C1/(C1+C2)*VDD depending upon the output polarity of the BBPD circuit 356.

It should be noted that the PLL circuit 300 is a schematic circuit representation and may include additional components and circuits, such as additional filters or smoothing capacitors, for example. Additionally, certain components or circuits may be replaced in the PLL circuit 300 with other components or circuits that function in a suitable manner as understood from the whole of this disclosure. For example, the particular shape and polarity of the many input and output signals throughout the PLL circuit 300 may be different between various implementations and may inform various aspects of the PLL circuit 300 for a given application as understood by those skilled in the art in view of this disclosure.

The proposed PLL circuit architecture of the PLL circuit 300 and other PLL circuits described herein may have the benefit of combining the advantages of quantization error free switch-resistor-proportional path control with small area and scalable capacitive-shared-integral path control. By replacing the traditional high impedance current sources used in charge pumps with switched resistors, the proposed PLL circuits may advantageously result in a simpler, more CMOS-friendly implementation with improved flicker noise performance.

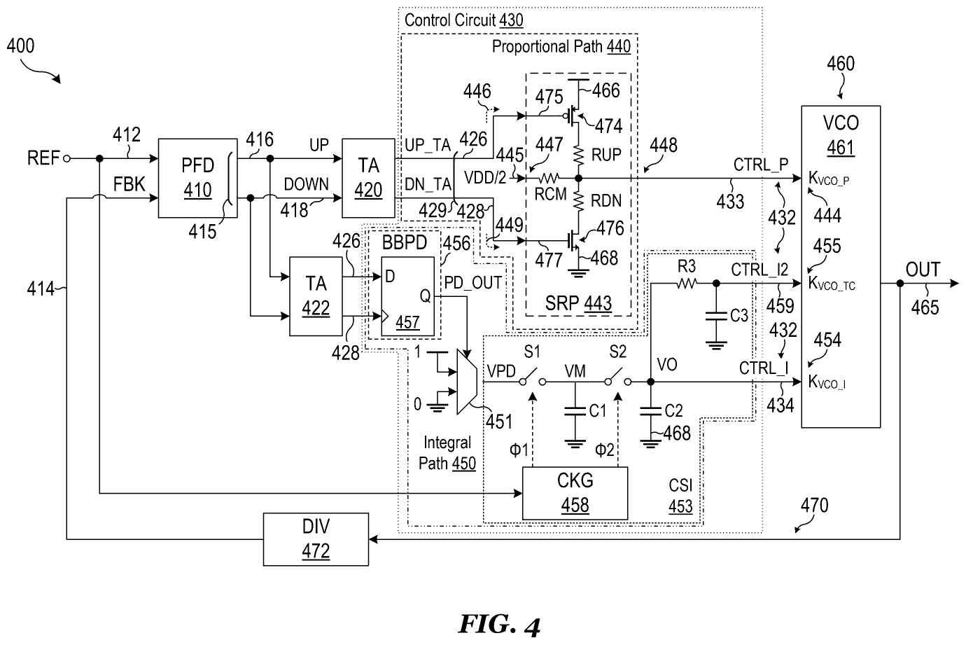

FIG. 4 illustrates another example PLL circuit that includes a TA circuit coupled between a PFD circuit and a control circuit with a proportional path with an SRP circuit and an integral path with a CSI circuit where the integral path is configured to output a second integral control signal in accordance with implementations of the invention. The PLL circuit of FIG. 4 may be a specific implementation of other PLL circuits described herein such as the PLL circuit of FIG. 2, for example. Similarly labeled elements may be as previously described.

Referring to FIG. 4, a PLL circuit 400 includes a PFD circuit 410 configured to output an UP signal 416 and a DOWN signal 418 as a phase error output 415 indicating the phase difference between a reference signal 412 (REF) and a feedback signal 414 (FBK) that is provided via a feedback loop 470 by passing an output signal 465 (OUT) through a frequency divider circuit 472. The phase error output 415 is provided to both a TA circuit 420 and an additional TA circuit 422 that that are each configured to amplify the phase difference between the UP signal 416 and the DOWN signal 418 to generate an extended phase error output 429 that includes a TA UP signal 426 (UP_TA) and a TA DOWN signal 428 (DN_TA).

A control circuit 430 receives the extended phase error output 429 and uses the TA UP signal 426 and the TA DOWN signal 428 to generate one or more control signals 432. The one or more control signals 432 are used to control a variable oscillator circuit 460, which is here implemented as a VCO circuit 461, to adjust the frequency of an output signal 465 (OUT) of the PLL circuit 400. The control circuit 430 generates multiple control signals using a proportional path 440 and an integral path 450.

The proportional path 440 includes a proportional control signal generation circuit implemented as an SRP circuit 443 that is configured to receive the TA UP signal 426 and the TA DOWN signal 428 and to generate a proportional control signal 433 (CTRL_P) of the one or more control signals 432. The integral path 450 includes an integrator circuit implemented as a CSI circuit 453 that is also configured to use the TA UP signal 426 and the TA DOWN signal 428 generated from the additional TA circuit 422 to generate at least one integral control signal 434 (both CTRL_I and CTRL_I2 in this specific example).

As before, the SRP circuit 443 of the proportional path 440 has an upper path 446 with a pull-up switch 474 controlling voltage to a pull-up resistor RUP from a supply voltage 466 and a lower path 449 with a pull-down switch 476 controlling voltage to a pull-down resistor RDN from a ground voltage 468. The SRP circuit 443 receives an intermediate input voltage 445 at a proportional input 447 and outputs a control voltage at a proportional output 448 through a common mode resistor RCM (e.g., centered around VDD/2 and transiently pulled up or down depending on the relative phases of the TA UP signal 426 coupled to a pull-up control input 475 and the TA DOWN signal 428 coupled to a pull-down control input 477). The proportional output 448 is provided to a proportional gain input 444 (K_{VCO_P}) of the VCO circuit 461 as the proportional control signal 433 (CTRL_P).

The integral path 450 includes a BBPD circuit 456 configured to generate a binary output signal PD_OUT that is provided at a selection input of a selector circuit 451 (e.g., a multiplexer). The selector circuit 451 is provides a digital phase detector output signal VPD to the CSI circuit 453. Similar to the previous CSI circuit implementation the switches S1 and S1 are controlled by respective clock signals Φ1 and Φ2, generated using a CKG circuit 458 that generates the first clock signal Φ1 and the second clock signal Φ2 using the reference signal 412. The voltage at the output node VO is provided as an integral control signal (CTRL_I) to an integral gain input 454 (K_{VCO_I}) of the VCO circuit 461.

In this specific example, the CSI circuit 453 has an additional output path 459 that includes a third integrating capacitor C3 coupled between a second output node V2 and the ground voltage 468. The additional output path 459 provides an additional integral control signal (CTRL_I2) at an additional gain input 455 of the VCO circuit 461. The third VCO control CTRL_I2 with a VCO gain of K_{VCO_TC} (e.g., about 1200 MHz/V in some implementations) is employed in this specific implementation. The pole of the R3C3 filter between CTRL_I and CTRL_I2 may be set between about 0.1 MHz to about 1 MHz (e.g., to suppress in-band phase noise or low frequency hump in the PLL phase noise profile).

For example, TC in K_{VCO_TC} may stand for temperature compensation. In order to reduce jitter peaking, it may be desirable to ensure the integration path gain through KVCO_I is much smaller than the proportional path gain through KVCO_P (in order to meet peak jitter requirements, for example). The additional control may be enabled by adding K_{VCO_TC} to act as temperature compensating control. The R3C3 filter may then dampen the AC response of the CTRL_I integration path gain to K_{VCO_TC}, leaving only (or substantially only) the DC response. I this way, the R3C3 filter may be used to both meet a jitter peaking requirement and to combat temperature drift.

The integral path 450 outputs two integral control signals in this representation, but any number is possible. The integral control signal 434 is influenced by a first combination of capacitors (C1 and C2) while the additional integral control signal (CTRL_I2) is influenced by a second combination of capacitors (C1, C2, and C3).

FIG. 5 illustrates an example TA circuit that includes a main discharge path and a dependent discharge path for each of an input UP signal and an input DOWN signal, where the TA circuit is configured to disable the dependent discharge path corresponding to the signal that discharges second in accordance with implementations of the invention. The TA circuit of FIG. 5 may be used in the PLL circuits described herein such as the PLL circuit of FIG. 1, for example. Similarly labeled elements may be as previously described.

Referring to FIG. 5, a TA circuit 520 receives a phase error output 515 that includes a UP signal 516 and a DOWN signal 518 in this specific example. The UP signal 516 is coupled to control inputs of a main UP discharge path 521 and a dependent UP discharge path 523 while the DOWN signal 518 is coupled to control inputs of a main DOWN discharge path 525 and a dependent DOWN discharge path 527. The TA circuit 520 is configured to delay the DOWN signal 518 by disabling the dependent DOWN discharge path 527 in response to the UP signal 516 leading the DOWN signal 518 (e.g., the rising edge of the UP signal 516 arrives at the TA circuit 520 before the rising edge of the UP signal 516 by a phase error of up to 180°). Similarly, the TA circuit 520 is configured to delay the UP signal 516 by disabling the dependent UP discharge path 523 in response to the DOWN signal 518 leading the UP signal 516.

The delay of either the UP signal 516 or the DOWN signal 518 produces an extended phase error output 529 that includes a TA UP signal 526 and a TA DOWN signal 528 at respective outputs of the TA circuit 520. For example, as schematically illustrated, the UP signal 516 and the DOWN signal 518 may arrive at the TA circuit 520 with a phase difference 517 (ΔT). The DOWN signal 518 is then delayed by a time scaling factor 513 (K_{TA}) so that the time between the TA UP signal 526 and the TA DOWN signal 528 becomes an extended phase difference 519 (ΔT+K_{TA}).

It should be noted that the time scaling factor 513 is shown as additive for the purposes of explanation. However, the time scaling factor 513 be a multiplicative factor in various implementations. Furthermore, the value of K_{TA} may be substantially constant or may have more complex behavior over a range of input frequencies and phase differences. The specific value and behavior of K_{TA} may depend on the details of a given application.

Each of the discharge paths are coupled between a supply voltage 566 and a ground voltage 568. In this specific implementation, an UP output inverter 571 and a DOWN output inverter 573 are used as output inverters for the TA UP signal 526 and the TA DOWN signal 528, respectively. However, it should be understood that the specific design details of the inputs and outputs of the TA circuit 520 may vary depending on various implementation details and the usage of the TA circuit 520 in a larger circuit, such as in one of the example PLL circuits described herein.

In the example implementation shown, the main UP discharge path 521 includes a main UP transistor switch U1 with a control input coupled to the UP signal 516, and the main DOWN discharge path 525 includes a main DOWN transistor switch D1 with a control input coupled to DOWN signal 518. The dependent UP discharge path 523 is coupled between a first node (UP) and the ground voltage 568. The dependent UP discharge path 523 includes a first dependent UP transistor switch U2 with a control input coupled to the UP signal 516 and includes a second dependent UP transistor switch U3 with a control input coupled to a second node (DOWN). The dependent DOWN discharge path 527 is coupled between the DOWN node and the ground voltage 568. The dependent DOWN discharge path 527 includes a first DOWN transistor switch D2 with a control input coupled to DOWN signal 518 and includes a second DOWN transistor switch D3 with a control input coupled to the UP node. Enable switches may also be included in each of the discharge paths, as shown.

While in this specific example the switches are implemented with certain components in a certain configuration and polarity, some or all of the switches may be implemented using other components and configurations that achieve the desired functionality of the TA circuit 520 as described using FIG. 5 as well as elsewhere throughout this disclosure.

FIG. 6 illustrates an example VCO circuit that includes a series of inverters coupled to a proportional control signal and one or more integral control signals through corresponding capacitive elements in accordance with implementations of the invention. The VCO circuit of FIG. 6 is a specific implementation of variable oscillator circuits used in the PLL circuits described herein such as the PLL circuit of FIG. 1, for example. Similarly labeled elements may be as previously described.

Referring to FIG. 6, a variable oscillator circuit 660 implemented as a VCO circuit 661 is configured to receive one or more control signals 632 and output an output signal 665 (OUT). The VCO circuit 661 has a proportional gain input 644 configured to receive a proportional control signal 633 (CTRL_P) and integral gain input 654 configured to receive an integral control signal 634 (CTRL_I). Optionally, the VCO circuit 661 may also include an additional gain input 655 configured to receive an additional integral control signal 635 (CTRL_I2). For example, the PLL circuit 400 of FIG. 4 is one example of a PLL circuit that includes an additional integral control signal. Of course, the VCO circuit 661 may also include other control inputs.

In this specific example, the VCO circuit 661 is implemented as a ring VCO circuit and includes a series of inverters 662 configured as a ring oscillator. The series of inverters 662 has 2n+1 inverters, with n being an integer. That is, the number of inverters in the series of inverters 662 is an odd number greater than or equal to three. The number of inverters in the series of inverters 662 may be chosen based on the details of a given application. In some cases, fewer inverters (i.e., fewer stages of the ring oscillator) may be desirable, such as to achieve a wider tuning range, lower power consumption, reduced circuit size, or for other reasons. In contrast, more inverters (more stages) may be desirable as well, such as to reduce phase noise, produce a more square output waveform, or for other reasons.

The VCO circuit 661 also includes various capacitive elements 663 (e.g., transistor capacitors, such as PMOS capacitors, as shown) coupled between the series of inverters 662 and the received control signals (e.g., the capacitive elements 663 provide capacitive loading, which may be varactor loading in some implementations, such as in the example shown). The capacitive elements 663 may be implemented an any suitable way and are configured to adjust the output signal 665 (e.g., the frequency of the output signal 665), such as by altering the delay between stages of the ring oscillator.

FIG. 7 illustrates an example digital VCO (DVCO) circuit that includes a series of inverters coupled to a proportional control signal, an integral control signal, and an m-bit digital control through corresponding capacitive elements in accordance with implementations of the invention. The DVCO circuit of FIG. 7 is a specific implementation of variable oscillator circuits used in the PLL circuits described herein such as the PLL circuit of FIG. 1, for example. Similarly labeled elements may be as previously described.

Referring to FIG. 7, a variable oscillator circuit 760 implemented as a VCO circuit 761 is configured to receive one or more control signals 732 and output an output signal 765 (OUT). The VCO circuit 761 has a proportional gain input 744 configured to receive a proportional control signal 733 (CTRL_P) and integral gain input 754 configured to receive an integral control signal 734 (CTRL_I). The VCO circuit 761 is implemented as a ring VCO circuit and includes a series of inverters 762 configured as a ring oscillator and various capacitive elements 763 coupled between the series of inverters 762 and the received control signals. In this specific example, the VCO circuit 761 is a DVCO circuit and is configured to receive a digital control signal 736 (D<m−1:0>), which is a digital signal with m bits, where m is an integer greater than or equal to 1. Each of the m bits is coupled to one or more of the stages of the ring oscillator through the capacitive elements 763.

FIG. 8 illustrates an example PLL circuit that includes multiple TA circuits cascaded between a PFD circuit and a control circuit configured to output one or more control signals to a variable oscillator circuit in accordance with implementations of the invention. The PLL circuit of FIG. 8 may be a specific implementation of other PLL circuits described herein such as the PLL circuit of FIG. 1, for example. Similarly labeled elements may be as previously described.

Referring to FIG. 8, a PLL circuit 800 includes a PFD circuit 810 configured to output an UP signal 816 and a DOWN signal 818 as a phase error output 815 indicating the phase difference between a reference signal 812 (REF) and a feedback signal 814 (FBK) that is provided via a feedback loop 870. The feedback loop 870 may provide an output signal 865 (OUT) directly as the feedback signal 814 or the feedback signal 814 may be generated by passing the output signal 865 through a frequency divider circuit 872.

In this specific example, the phase error output 815 is provided to a series of TA circuits 824 including multiple TA circuits 820 cascaded between the PFD circuit 810 and a control circuit 830. The control circuit 830 receives the extended phase error output 829 and uses the TA UP signal 826 and the TA DOWN signal 828 to generate one or more control signals 832 (CTRL). The one or more control signals 832 are used to control a variable oscillator circuit 860 to adjust the frequency of an output signal 865 (OUT) of the PLL circuit 800.

Each of the series of TA circuits 824 are configured to amplify the phase difference between the UP signal 816 and the DOWN signal 818 to generate an extended phase error output 829 that includes a TA UP signal 826 (UP_TA) and a TA DOWN signal 828 (DN_TA). That is, the aggregate delay of the series of TA circuits 824 is output to the control circuit 830. Each of the TA circuits 820 may be the same or different from one another. Additionally, enable inputs may be included in the TA circuits 820 which may allow the total delay of the series of TA circuits 824 to be changed depending on the combination of TA circuits that are selected (enabled).

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular implementations described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding implementations described herein. Accordingly, the appended claims are intended to include within their scope such processes, machines, manufacture, compositions of matter, means, methods, or steps.

What is claimed is:

1. A phase-locked loop (PLL) circuit comprising:
a phase-frequency detector (PFD) circuit configured to receive a reference signal and a feedback signal and to generate a phase error output indicating a phase difference between the reference signal and the feedback signal;
a time amplifier (TA) circuit configured to receive the phase error output and extend the phase difference by a time scaling factor to generate an extended phase error output;
a control circuit configured to output one or more control signals generated using the extended phase error output; and
a variable oscillator circuit configured to use the one or more control signals to adjust a frequency of an output signal of the PLL circuit, the feedback signal being generated using the output signal.

2. The PLL circuit of claim 1, wherein the control circuit comprises
a proportional path comprising an analog control signal generation circuit coupled between the TA circuit and the variable oscillator circuit, the analog control signal generation circuit being configured to output a proportional control signal of the one or more control signals, and
an integral path comprising an integrator circuit coupled between the TA circuit and the variable oscillator circuit, the integrator circuit being configured to output an integral control signal of the of the one or more control signals.

3. The PLL circuit of claim 2, wherein the analog control signal generation circuit comprises a switched-resistor proportional (SRP) circuit comprising
a common mode resistor coupled between a proportional input and a proportional output,
an upper path coupled between a supply voltage and the proportional output, the upper path comprising a pull-up switch in series with a pull-up resistor, a control input of the pull-up switch being coupled to a TA UP signal of the extended phase error output, and
a lower path coupled between a ground voltage and the proportional output, the lower path comprising a pull-down switch in series with a pull-down resistor, a control input of the pull-down switch being coupled to a TA DOWN signal of the extended phase error output.

4. The PLL circuit of claim 2, wherein the integrator circuit comprises a capacitive-shared-integration (CSI) circuit comprising
a first switch coupled between the extended phase error output and a middle node,
a second switch coupled between the middle node and an output node,
a first integrating capacitor coupled between the middle node and a ground voltage,
a second integrating capacitor coupled between the output node and the ground voltage, and
a non-overlapping clock generator circuit configured to
receive the reference signal,
output a first clock signal to a control input of the first switch, and
output a second clock signal to a control input of the second switch.

5. The PLL circuit of claim 2, wherein the integral control signal that is output by the integrator circuit comprises a first integral control signal generated using a first combination of capacitors and a second integral control signal generated using a second combination of capacitors different from the first combination.

6. The PLL circuit of claim 1, wherein the variable oscillator circuit is a voltage-controlled oscillator (VCO) circuit.

7. The PLL circuit of claim 1, further comprising:
a frequency divider circuit configured to receive the output signal and divide the frequency by a frequency scaling factor to generate the feedback signal.

8. A phase-locked loop (PLL) circuit comprising:
a phase-frequency detector (PFD) circuit configured to receive a reference signal and a feedback signal and to generate a phase error output indicating a phase difference between the reference signal and the feedback signal;
a time amplifier (TA) circuit configured to receive the phase error output and extend the phase difference by a time scaling factor to generate an extended phase error output;
a voltage-controlled oscillator (VCO) circuit configured to use one or more control signals to adjust a frequency of an output signal of the PLL circuit, the feedback signal being generated using the output signal; and
a control circuit configured to output the one or more control signals generated using the extended phase error output, the control circuit comprising
a proportional path comprising an analog control signal generation circuit coupled between the TA circuit and the VCO circuit, the analog control signal generation circuit being configured to output a proportional control signal of the one or more control signals, and
an integral path comprising an integrator circuit coupled between the TA circuit and the VCO circuit, the integrator circuit being configured to output an integral control signal of the of the one or more control signals.

9. The PLL circuit of claim 8, wherein the analog control signal generation circuit comprises a switched-resistor proportional (SRP) circuit comprising
a common mode resistor coupled between a proportional input and a proportional output,
an upper path coupled between a supply voltage and the proportional output, the upper path comprising a pull-up switch in series with a pull-up resistor, a control input of the pull-up switch being coupled to a TA UP signal of the extended phase error output, and
a lower path coupled between a ground voltage and the proportional output, the lower path comprising an pull-down switch in series with a pull-down resistor, a control input of the pull-down switch being coupled to a TA DOWN signal of the extended phase error output.

10. The PLL circuit of claim 8, wherein the integrator circuit comprises a capacitive-shared-integration (CSI) circuit comprising
a first switch coupled between the extended phase error output and a middle node,
a second switch coupled between the middle node and an output node,
a first integrating capacitor coupled between the middle node and a ground voltage,
a second integrating capacitor coupled between the output node and the ground voltage, and
a non-overlapping clock generator circuit configured to
receive the reference signal,
output a first clock signal to a control input of the first switch, and
output a second clock signal to a control input of the second switch.

11. The PLL circuit of claim 10, wherein the integral path further comprises a bang-bang phase detector (BBPD) circuit coupled between the TA circuit and the CSI circuit, the BBPD circuit being configured to output a binary signal indicating whether the reference signal leads or lags the feedback signal.

12. The PLL circuit of claim 10, wherein the CSI circuit further comprises an additional output path coupled to the output node, the additional output path comprising a resistor in series with a third integrating capacitor.

13. The PLL circuit of claim 8,
wherein the phase error output comprises an UP signal and a DOWN signal,
wherein the extended phase error output comprises a TA UP signal and a TA DOWN signal, and
wherein the TA circuit is configured to
delay the TA DOWN signal by disabling a dependent DOWN discharge path in response to the UP signal leading the DOWN signal, and
delay the TA UP signal by disabling a dependent UP discharge path in response to the DOWN signal leading the UP signal.

14. The PLL circuit of claim 13, wherein the TA circuit comprises
a main UP discharge path comprising a main UP transistor switch with a control input coupled to the UP signal, and
a main DOWN discharge path comprising a main DOWN transistor switch with a control input coupled to the DOWN signal,
wherein the dependent UP discharge path is coupled between a first node and a ground voltage and comprises a first dependent UP transistor switch with a control input coupled to the UP signal, and a second dependent UP transistor switch with a control input coupled to a second node, and
wherein the dependent DOWN discharge path is coupled between the second node and the ground voltage and comprises a first DOWN transistor switch with a control input coupled to the DOWN signal, and a second DOWN transistor switch with a control input coupled to the first node.

15. The PLL circuit of claim 8, wherein the VCO circuit is a digital voltage-controlled oscillator (DVCO) circuit.

16. The PLL circuit of claim 8, further comprising:
a frequency divider circuit configured to receive the output signal and divide the frequency by a frequency scaling factor to generate the feedback signal.

17. A method of generating an output signal using a reference signal received by a phase-locked loop (PLL) circuit, the method comprising:
generating, by a phase-frequency detector (PFD) circuit of the PLL circuit, an UP signal and a DOWN signal indicating a phase difference between the reference signal and a feedback signal;
extending, by a time amplifier (TA) circuit of the PLL circuit, the phase difference of the UP signal and the DOWN signal by a time scaling factor to generate an extended phase error output comprising a TA UP signal and a TA DOWN signal indicating an extended phase difference;
generating one or more control signals using the extended phase difference; and
a frequency adjusted by the one or more control signals according to the extended phase difference.

18. The method of claim 17, wherein generating the one or more control signals using the extended phase difference comprises
generating a proportional control signal using an analog switched-resistor proportional (SRP) circuit by
controlling current through a pull-up resistor using a pull-up switch coupled to the TA UP signal, and
controlling current through a pull-down resistor using a pull-down switch coupled to the TA DOWN signal, and
generating at least one integral control signal using a capacitive-shared-integration (CSI) circuit by sharing charge between a first integrating capacitor coupled between a middle node of the CSI circuit and a ground voltage and a second integrating capacitor coupled between an output node of the CSI circuit and the ground voltage using a first switch coupled between the extended phase error output and the middle node, and a second switch coupled between the middle node and the output node.

19. The method of claim 18, wherein generating the at least one integral control signal using the CSI circuit comprises generating a binary signal indicating whether the reference signal leads or lags the feedback signal using a bang-bang phase detector (BBPD) circuit coupled between the extended phase error output and the first switch.

20. The method of claim 19, wherein generating the at least one integral control signal using the CSI circuit further comprises
generating a first integral control signal at the output node using the first integrating capacitor and the second integrating capacitor, and
generating a second integral control signal at an additional output node using the first integrating capacitor, the second integrating capacitor, and a third integrating capacitor in series with a resistor between the output node and the additional output node.
